(19) United States
(12) Patent Application Publication
(10) Pub. No.: US 2015/0036208 A1
(43) Pub. Date: Feb. 5, 2015

(54) ELECTROPHORETIC DISPLAY DEVICE

(71) Applicant: Dai Nippon Printing Co., Ltd., Tokyo (JP)

(72) Inventors: Masanori Umeya, Tokyo (JP); Nanae Tagaya, Tokyo (JP); Toru Miyoshi, Tokyo (JP)

(21) Appl. No.: 14/384,895

(22) PCT Filed: Mar. 14, 2013
(86) PCT No.: PCT/JP2013/057255

§ 371 Date: Sep. 12, 2014

(30) Foreign Application Priority Data
Mar. 14, 2012 (JP) 2012-057812

(51) Int. Cl. G02F 1/167; B32B 37/14; G02F 1/1333

(52) U.S. Cl. CPC G02F 1/167; G02F 1/1333; G02F 1/133308; B32B 37/14
USPC 359/296; 156/146

(57) ABSTRACT

The present invention is an electrophoretic display device including a display medium containing electrophoretic elements of at least one or more kind(s), which is enclosed between opposed two substrates at least one of which is transparent, the display medium being configured to display predetermined information when a predetermined electric field is applied between the two substrates, wherein: a partition wall is formed in a predetermined pattern on one substrate; the display medium is located in each of cells which are areas divided by the partition wall; and the other substrate is adhered partially to a top surface of the partition wall, so that a not-adhered portion remains.

### FIELD OF THE INVENTION

The present invention relates to an electrophoretic display device applied to an electronic paper and so on.

### BACKGROUND ART

An electrophoretic display device is a device for displaying information, by utilizing electric migration of electrophoretic elements (generally particles that electrically migrate), i.e., movement of particles, in an air or a solvent. In general, an electric migration condition is controlled by applying an electric field between two substrates, so that a desired display can be achieved.

Application of an electrophoretic display device particularly to an electronic paper has been widely regarded in recent years. When applied as an electronic paper, the electrophoretic display device has advantages such as visibility of printed matter level (easy on the eyes), easiness in rewriting of information, low power of consumption, light weight and the like.

However, in the electrophoretic display device, unsatisfactory display, in particular, low contrast may sometimes occur, because of precipitation or uneven distribution of particles. In order to prevent this phenomenon, a partition wall is formed between upper and lower electrode substrates, so as to divide a migration space, i.e., a movement space in which particles electrically migrate, into small spaces. The small space is called cell or pixel. Each of the cells encloses an ink (display medium) containing electrophoretic elements. For example, Patent Document 1 (JP2005-202245A) discloses a conventional example of an electrophoretic display device of this type.

In addition, Patent Document 2 (JP2012-013790A) of the Applicant of the present invention discloses a method in which a partition wall and a substrate are reliably adhered to each other, by applying an adhesive agent only onto a partition wall that defines cells.

### SUMMARY OF THE INVENTION

The present inventor has conducted extensive studies on the adhesive condition between a partition wall and a substrate, and found as follows.

In a case where adhesion between a partition wall and a substrate is insufficient, when a local pressure is applied from outside, the display medium moves between cells, so that so-called display irregularity (pressure trace) is generated. Such a phenomenon has been conventionally pointed out.

In addition, the present inventor has found the following phenomenon. That is, in a case where adhesion between a partition wall and a substrate is nearly perfect, when a local pressure is applied from outside, since there is no “escape space” for the display medium in cells, a cell structure tends to be destroyed. The present inventor has further found that, in a case where adhesion between the partition wall and the substrate is nearly perfect, when an inside of the cell is under negative pressure condition, bubbles are likely to generate in the cell with time, which may invite unsatisfactory display.

The present invention has been made in view of the above circumstances. The object of the preset invention is to provide: an electrophoretic display device which is free of display irregularity and unsatisfactory display, with a cell being hardly destroyed, when a local pressure is applied from outside; and a method of manufacturing such an electrophoretic display device.

The present invention is an electrophoretic display device including a display medium containing electrophoretic elements of at least one or more kind(s), which is enclosed between opposed two substrates at least one of which is transparent, the display medium being configured to display predetermined information when a predetermined electric field is applied between the two substrates, wherein: a partition wall is formed in a predetermined pattern on one substrate; the display medium is located in each of cells which are areas divided by the partition wall; and the other substrate is adhered partially to a top surface of the partition wall, so that a not-adhered portion remains.

According to the present invention, since the other substrate is adhered partially to the top surface of the partition wall, neither display irregularity nor unsatisfactory display occurs without any destruction, when a local pressure is applied from outside.

Preferably, the top surface of the partition wall and the other plate are adhered to each other at a range of 50 to 80% relative to a total area of the top surface of the partition wall.

For example, the top surface of the partition wall and the other substrate are adhered to each other by a heat sealing agent.

In addition, the present invention is a method of manufacturing an electrophoretic display device including a display medium containing electrophoretic elements of at least one or more kind(s), which is enclosed between opposed two substrates at least one of which is transparent, the display medium being configured to display predetermined information when a predetermined electric field is applied between the two substrates, the method including: a step of forming a partition wall in which a partition wall is formed in a predetermined pattern on one substrate; a step of locating a display medium in which the display medium is located in each of cells which are areas divided by the partition wall; and a step of adhering the other substrate in which the other substrate is adhered partially to a top surface of the one substrate.

Preferably, in the step of adhering the other substrate, the other substrate is adhered at a range of 50 to 80% relative to a total area of the top surface of the partition wall.

For example, the step of adhering the other substrate includes: a step of forming an adhesive layer in which a heat sealing agent is transferred as an adhesive layer to the whole top surface of the partition wall; and a heating step in which the transferred heat sealing agent is softened to provide an adhesive force. In this case, for example, by adjusting a thickness of the heat sealing agent and a contact bonding pressure obtained after the heat sealing agent has been heated to provide an adhesive force, the other substrate can be adhered only partially to the top surface of the partition wall.

### BRIEF DESCRIPTION OF THE DRAWINGS

FIG. 1 is a sectional view schematically showing a structure of an electrophoretic display device according to one embodiment of the present invention.

FIG. 2 is a flowchart schematically showing a method of manufacturing the electrophoretic display device according to the one embodiment of the present invention.

FIG. 3 is a view schematically showing an example of a step of forming a partition wall.

FIG. 4 is a view schematically showing an example of a step of forming an adhesive layer.

FIG. 5 is a view schematically showing an example of a step of locating a display medium.

FIG. 6 is a schematic view for explaining a function of a conductive paste.

FIG. 7 is a view schematically showing an example of a step of adhering the other substrate.

FIG. 8 is a view for explaining a definition of a width of a top surface of a partition wall 12.

FIG. 9 is a diagram showing a correspondence between pattern examples observed by a microscope and adhesive area ratios.

### EMBODIMENT FOR CARRYING OUT INVENTION

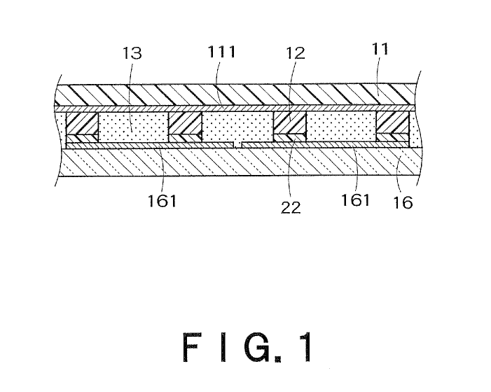

FIG. 1 is a sectional view schematically showing a structure of an electrophoretic display device according to one embodiment of the present invention. The electrophoretic display device according to this embodiment includes a display medium 13 containing an electric responsive material of at least one or more kind(s), which is enclosed between two opposed substrates 11 and 16 on which electrodes 111 and 161 are respectively formed, at least one of the substrates 11 and 16 being transparent. When a predetermined electric field is applied between the two substrates 11 and 16, a desired display is provided by the display medium 13.

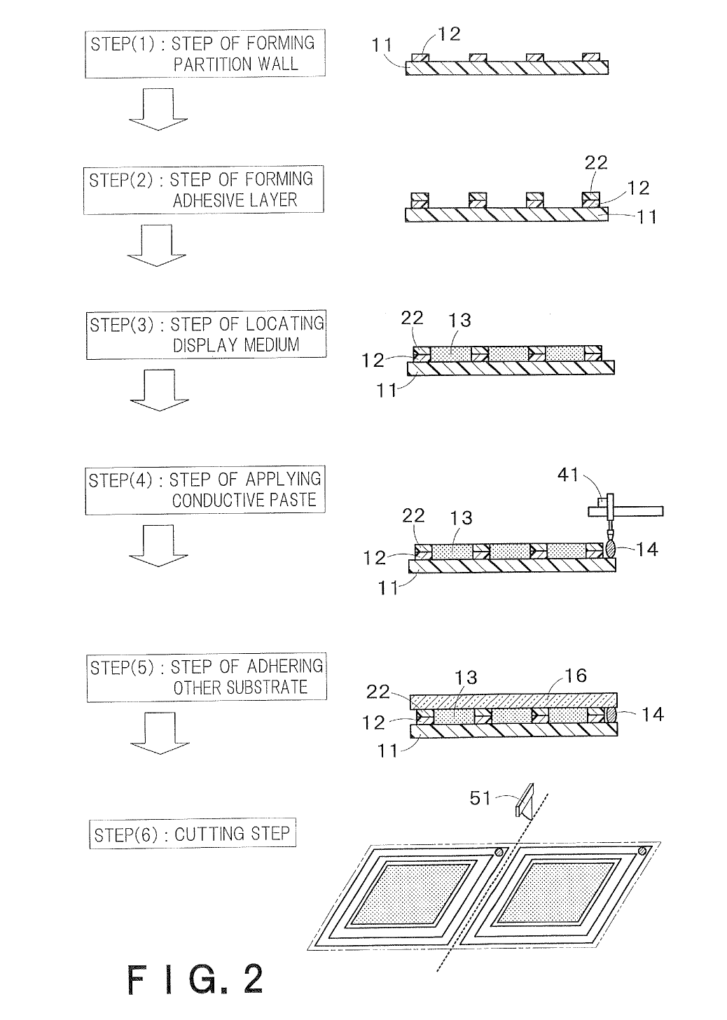

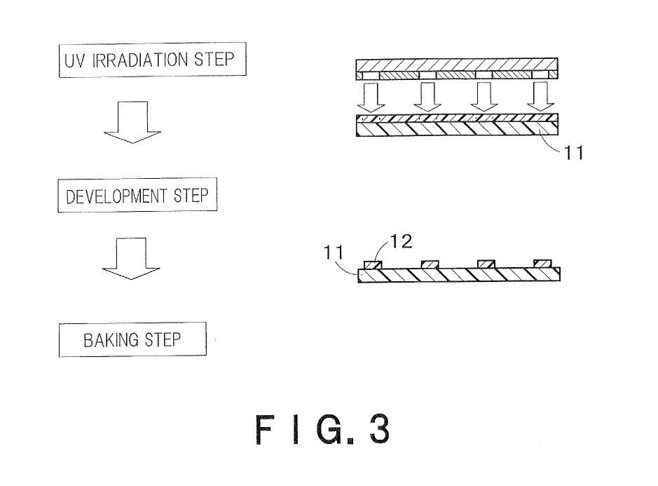

FIG. 2 is a flowchart schematically showing a method of manufacturing the electrophoretic display device according to the embodiment of the present invention. FIG. 3 is a view schematically showing an example of a step of forming a partition wall. As shown in FIG. 3, a partition wall 12 of a predetermined pattern is generally formed on an upper surface of the one substrate 11 (back plane base material (BP)) that is horizontally placed, by a photolithographic method (exposure by ultraviolet light (UV) radiation development baking), for example. The partition wall 12 is a member for defining side surfaces and lower surfaces of a plurality of cells described below. A thickness of the partition wall is 5 to 50 μm, preferably, 8 to 30 μm. The cell has a pitch of 0.05 to 1 mm, preferably, 0.1 to 0.5 mm, although it depends on dimensions of a display panel.

In this specification, the “cells” mean small migration spaces, i.e., movement spaces in which particles and grains electrically migrate, which are divided by a partition wall formed between upper and lower electrode substrates, in order to prevent unsatisfactory display, in particular, low contrast caused by precipitation or uneven distribution of particles or grains.

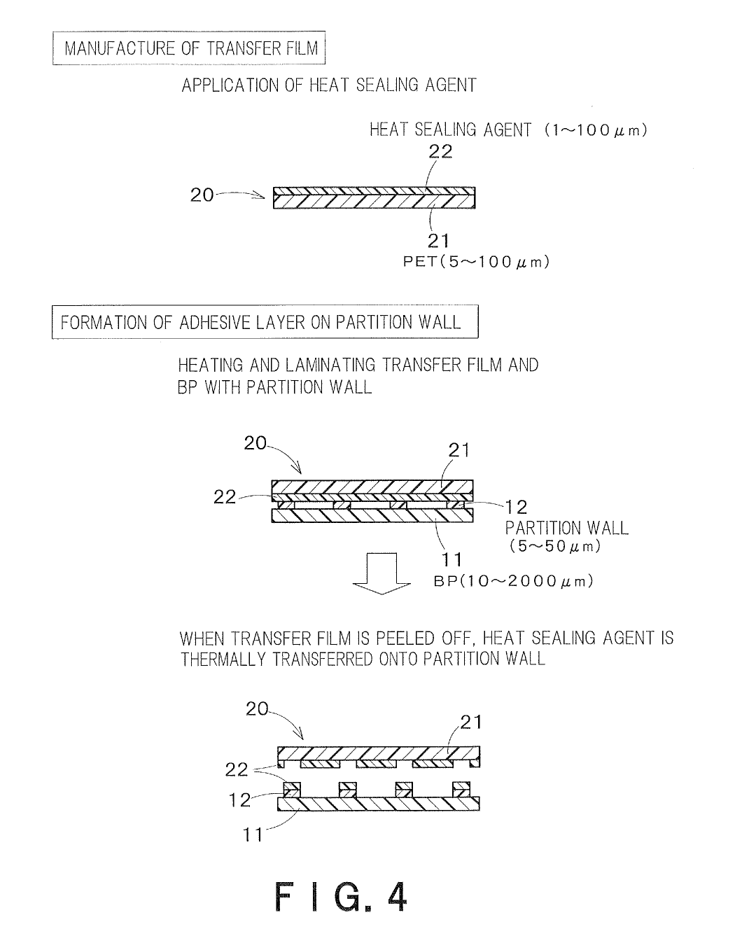

Then, an adhesive layer is formed on the partition wall 12 (step of forming adhesive layer). FIG. 4 is a view showing an example of the step of forming an adhesive layer. In the step of forming an adhesive layer shown in FIG. 4, a heat sealing agent 22 (hereinafter referred to also as “adhesive layer”) is firstly applied to a transfer film base material 21 formed of, e.g., polyethylene terephthalate (PET) film, so that a transfer film 20 is formed. The heat sealing agent 22 is applied with a thickness of 1 to 100 μm, more preferably, applied with a thickness of 1 to 50 μm, most preferably applied with a thickness of 1 to 10 μm. As described below, the heat sealing agent 22 is made of a thermoplastic resin.

The transfer film 20 is placed on the partition wall 12 such that a surface of the transfer film 20 on the side of the heat sealing agent faces the partition wall 12. Then, the transfer film 20 is heated up to a temperature over its softening temperature, with only a self weight of the transfer film 20 being applied to the partition wall 12, or a further predetermined pressing force being applied thereto (heat lamination: thermal transfer). Thereafter, the transfer film 20 is peeled, so that the heat sealing agent 22, which has been thermally transferred onto the partition wall 12, remains thereon.

In this embodiment, the heat sealing agent 22 is thermally transferred to a whole top surface of the partition wall 12. A pressure force upon thermal transfer is preferably, e.g., about 1 kPa. When a pressing force is too small, the transfer of the heat sealing agent from the transfer film is insufficient. On the other hand, when a pressing force is too large, there is a possibility that the heat sealing agent might collapse to come into a cell and/or that a heat sealing agent other than the partition wall pattern may be transferred. A heating temperature upon thermal transfer is preferably about 120° C.

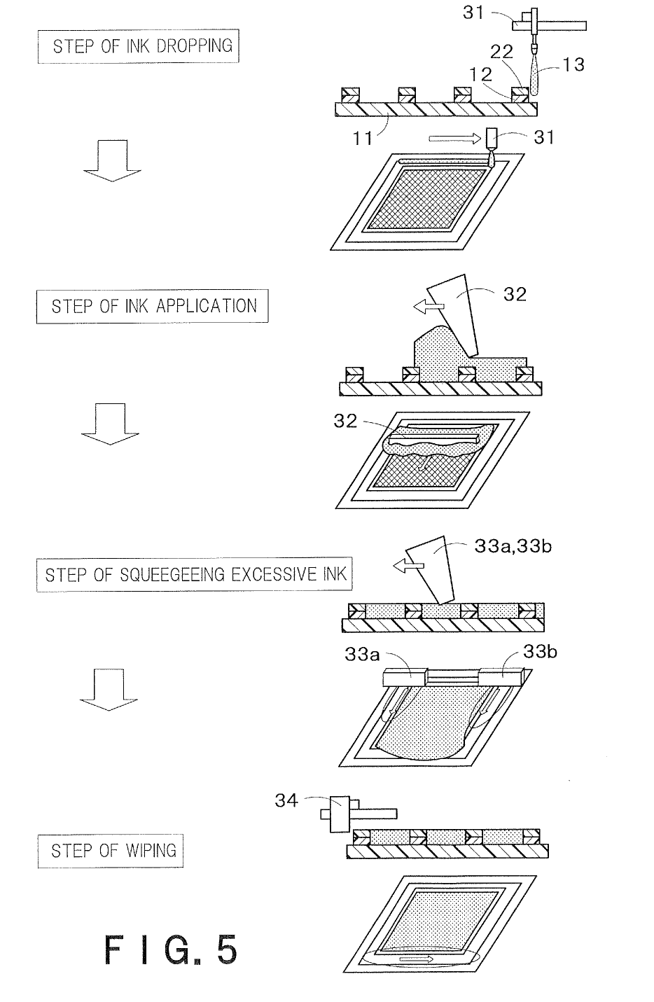

Returning to FIG. 2, after the formation of the adhesive layer (heat sealing agent) 22, an ink 13 as a display medium is located in areas divided by the partition wall 12 or by the partition wall 12 and the adhesive layer 22 (step of locating display medium). FIG. 5 is a view schematically showing an example of the step of locating the display medium. Herein, (1) the ink 13 is dropped down from a dispenser 31 or an ink jet/a die coater, (2) the ink 13 is uniformly applied in a plane, by a central squeegee 32 or a doctor blade/a doctor knife, (3) the excessive ink protruding at both sides is trimmed off by side squeegees 33a and 33b or a doctor blade/doctor knife, and (4) the excessive ink built up on one side is wiped out by a wiper 34.

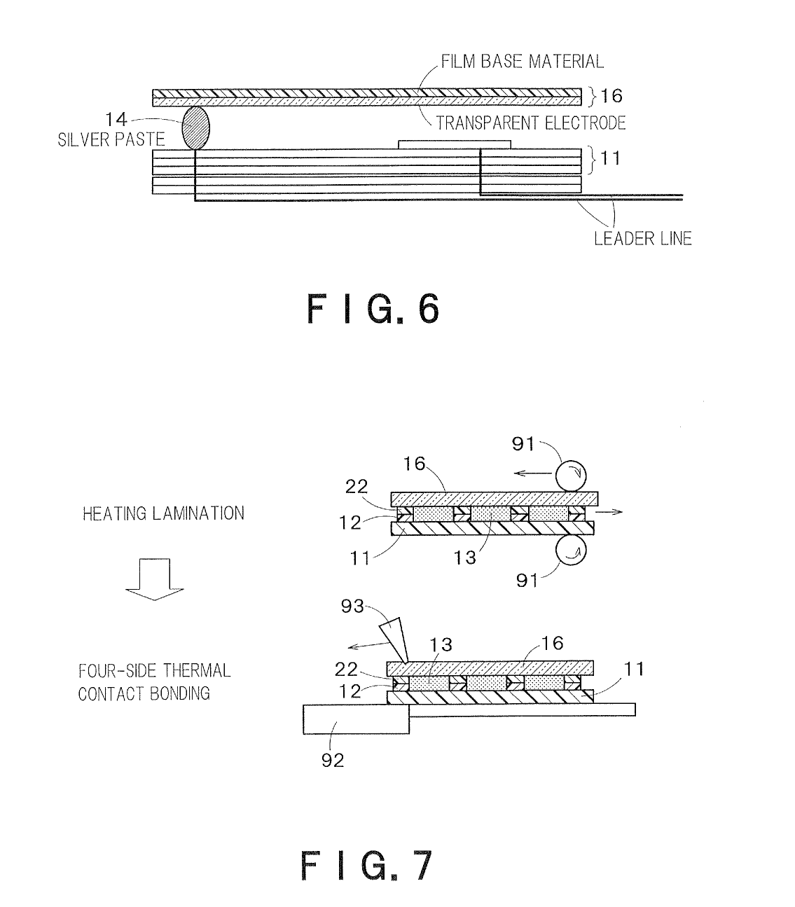

Returning to FIG. 2, after the step of locating the display medium, a step of applying a conductive paste is performed. FIG. 6 is a schematic view for explaining a function of the conductive paste. The conductive paste 14 is a metal paste such as a silver paste. The conductive paste 14 is applied to a predetermined position by, for example, a dispenser 41, or an ink jet/a padding printing/a pad printing/a stumping printing. As shown in FIG. 6, the conductive paste 14 functions as a wiring for applying voltage to the other substrate 16 (front plane base material (FP)). When a predetermined electric field (voltage) is applied between an electrode pattern of the one substrate 11 and an electrode pattern of the other substrate 16, electrophoretic particles in the ink 13, which is the display medium, are driven, so that predetermined information such as a character pattern is displayed. After that, even when no electric field is applied any more, the information displayed condition is maintained until a new electric field is applied between the both substrates.

Thereafter, the other substrate 16 to be opposed to the one substrate 11 is adhered onto the adhesive layer 22 on the partition wall 12 (step of adhering the other substrate). Thus, respective upper surfaces of the plurality of cells are defined, whereby the display medium (ink 13) is enclosed in the respective cells.

As shown in FIG. 7, in the step of adhering the other substrate, an adhesive force is obtained by heating the heat sealing agent 22 having been transferred as an adhesive layer. To be specific, the heat sealing agent 22 is heated from a periphery thereof up to a temperature over its softening temperature so as to be softened, while a predetermined thermal contact bonding pressure, i.e., a lamination pressure is applied by a laminator 91, whereby the partition wall 12 and the other substrate 16 are adhered to each other.

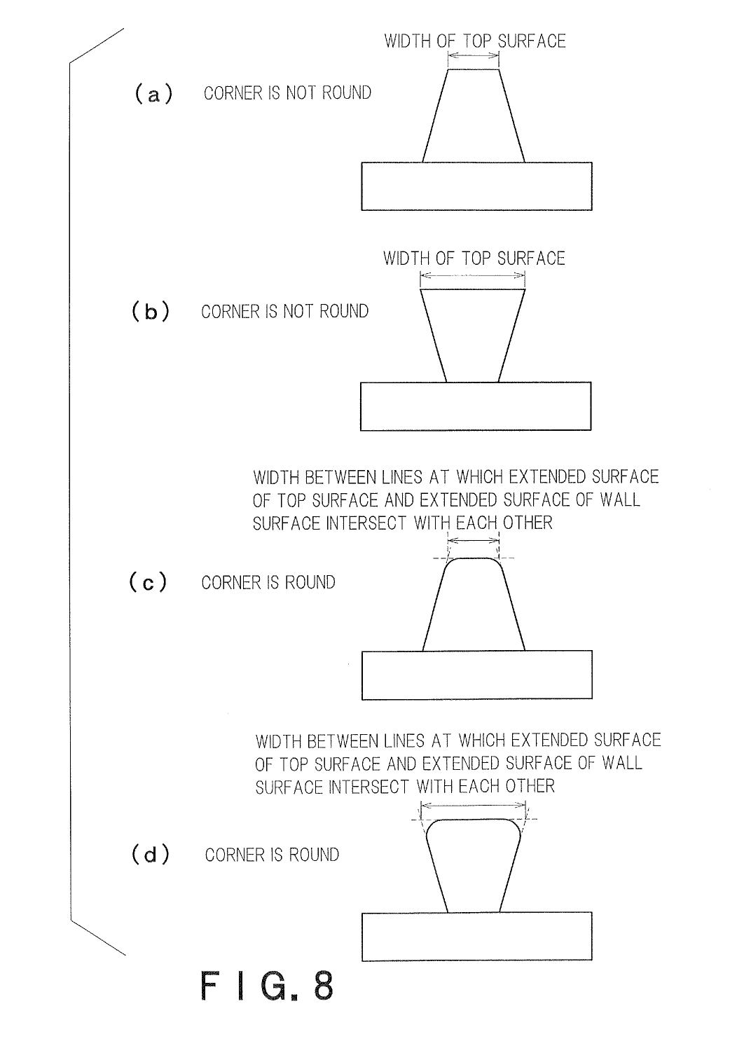

In this embodiment, by suitably selecting a thermal contact bonding pressure depending on a thickness of the heat sealing agent 22, the other substrate 16 is adhered only partially to the top surface of the partition wall 12, although the adhesive layer has been thermally transferred to the whole top surface of the partition wall 12. In more detail, it was found that, by suitably selecting a thermal contact bonding pressure depending on a thickness of the heat sealing agent 22, the softened heat sealing agent 22 tends to build up at an intersection point in the top surface of the partition wall 12, while an amount of the softened heat sealing agent 22 tends to be smaller at an intermediate area between intersection points in the top surface of the partition wall 12 (a not-adhered portion remains) (see FIG. 8, details will be described hereafter).

Moreover, in this embodiment, after the adhering operation by the laminator 91, there is further performed a four-side thermal contact bonding step in which four sides (peripheral part) of the substrate 11 and four sides (peripheral part) of the substrate 16 are thermally contact bonded to each other. Specifically, a hot plate 92 is laid below the four sides (peripheral part) of each of the substrates 11 and 16, and a lamination pressure is applied by a metal piece 93 from inside to outside, to the four sides of each of the substrates 11 and 16.

After that, as shown in FIG. 2, the thus obtained structure is cut to a predetermined size by a cutting device 51 such as a guillotine, an upper blade sliding device, a laser cutting device or a laser cutter. Thereafter, an outer periphery sealing treatment is carried out, so that the manufacture of a desired electrophoretic display device is completed.

As described above, according to this embodiment, with the use of the heat sealing agent 22 as an adhesive layer, adhesion of the partition wall 12 and the other substrate 16 for forming the cells can be suitably performed, although by a simple process. In addition, since the transfer film 20 is used when the heat sealing agent 22 is thermally transferred, a highly precise alignment of the heat sealing agent 22 onto the partition wall 12 is not necessary, as well as the heat sealing agent 22 can be thermally transferred only to the top surface of the partition wall 12 reliably.

When the heat sealing agent 22 thermally transferred as an adhesive layer is formed of a thermoplastic material, since the heat sealing agent 22 is free of tackiness at normal temperatures, it is very easy and convenient to handle it. In addition, since the heat sealing agent 22 is free of tackiness, the subsequent step of locating the display medium can be facilitated. To be specific, when the display medium is located by using a squeegee, a doctor blade, a doctor knife or the like, there is no possibility that the display medium (ink 13) adheres to the heat sealing agent 22.

In addition, according to this embodiment, in the step of adhering the other substrate (FIG. 7), by suitably selecting a thermal contact bonding pressure depending on a thickness of the heat sealing agent 22, the other substrate 16 is adhered only partially to the top surface of the partition wall 12, although the adhesive layer has been thermally transferred to the whole top surface of the partition wall 12. Thus, the adhesion degree between the top surface of the partition wall 12 and the other substrate 16 is well balanced. Thus, when a local pressure is applied from outside, a movement (escape) of the display medium is maintained at a suitable level. Thus, neither display irregularity nor unsatisfactory display occurs, as well as destruction of the cells does not take place.

To be more specific, when an adhesion area ratio is less than 50%, a flow path of the display medium is formed at a not-adhered portion, by deformation of a gap between the substrates, which is caused by an external pressure. Thus, the display medium flows to invite display irregularity. On the other hand, when an adhesion area ratio exceeds 80%, a cross sectional area of the flow path of the display medium is so small that a resistance is increased. Thus, when an external pressure is abruptly applied, increase of internal pressure of the cell cannot be restrained to invite destruction of the partition wall.

Next, materials and characteristics of respective members of the electrophoretic display device, which is an object of the present invention to be manufactured, are additionally described in more detail.

As the one substrate 11, there may be used a substrate made of a resin film, a resin plate, a glass, an epoxy glass, a ceramic or the like, on which surface an electrode is formed by a conductive material such as a metal. Alternatively, a metal plate or a light transmissible base material may be used. As an opaque base material, there may be used an opaque glass base material in which the other surface different from an electrode surface is roughened, an opaque base material in which a metal film is vapor deposited on the other surface different from an electrode surface, an opaque resin base material mixed with a dye or a pigment, etc.

A thickness of the one substrate 11 is preferably 10 μm to 2 mm. When the thickness is smaller than 10 μm, a strength required for a panel cannot be obtained, whereby there is an increased risk of destruction. On the other hand, when the thickness is larger than 2 mm, a weight of the panel is so heavy that it is difficult to handle, as well as a cost is increased.

A range of a suitable thickness of the substrate 11 which is unlikely to be destroyed but easy to be handled is about 50 μm to 100 μm.

A surface of the one substrate 11 may be subjected to an oxidation prevention treatment by a plating treatment. In addition, a barrier layer may be provided on a rear surface (outside) of the one substrate 11. A function of the barrier layer is to prevent display deterioration that is caused when the ink absorbs moisture. The barrier layer on the upper substrate is transparent, while the barrier layer on the lower substrate may be transparent or opaque. The barrier layer may be provided by vapor depositing an inorganic film. Alternatively, a film on which the barrier layer has been formed beforehand may be laminated onto the substrate. An electrode patterning of the one substrate 11 may be carried out by a photolithographic method, a laser drawing method, an ink jet method, a screen printing method, a flexographic printing method and so on. A TFT substrate may be used as the one substrate 11.

The one substrate 11 may be in a rolled condition or in a sheet condition.

The partition wall 12 can be made of an ultrasonic curing resin, a thermoset resin, a cold setting resin and so on. As described above, the partition wall 12 preferably has a thickness of 5 to 50 μm. When the thickness is 5 μm or less, an amount of ink to be filled is small, so that a sufficient display property, in particular, a sufficient contrast cannot be obtained. On the other hand, when the thickness is 100 μm or more, a thickness of the panel is so large that a driving voltage is excessively increased. From a viewpoint that an excellent display property can be obtained with a low driving voltage, the thickness within a range of 10 to 50 μm is preferable.

A pattern shape of the partition wall 12 is basically optional. For example, a circular shape, a lattice shape, a polygonal shape and so on are possible. An open area ratio is preferably 70% or more, in particular, 90% or more. As an open area ratio is increased, a displayable area is broadened, whereby a high contrast can be obtained.

As a method of forming the partition wall 12, a pattern transfer method such as embossing may be employed, in addition to a photolithographic method. Further, there may be employed a method in which a meshed structure is manufactured as the partition wall and the meshed structure is laminated onto the one substrate 11.

The heat sealing agent 22 is preferably formed of a thermoplastic material. Namely, the thermoplastic material is softened when heated, and is solidified when cooled. When cooling and heating are repeated, the plastic behavior is maintained reversible. When the heat sealing agent formed of such a thermoplastic material is used as an adhesive layer, by heating the heat sealing agent, which has been solidified on the transfer film base material, up to a temperature over its softened temperature, the heat sealing agent is softened so as to be thermally transferred only to the top surface of the partition wall reliably. In addition, after the thermal transfer operation, the heat sealing agent is cooled down to normal temperatures so as to be solidified again. Namely, since the solidified heat sealing agent is free of tackiness, it is very easy to handle. In addition, since the heat sealing agent is free of tackiness, there is no possibility that the display medium filled in the cells adheres to the heat sealing agent. When the heat sealing agent on the top surface of the partition wall is again heated up to a temperature over its softening temperature, the heat sealing agent is softened to have tackiness. Thus, the other substrate can be reliably adhered thereto. Since the heat sealing agent having been adhered to the other substrate is free of tackiness at normal temperatures, the display medium also does not adhere to the heat sealing agent. Thus, there is no possibility that display quality is deteriorated. Specifically, there is mainly used a resin with an adhesive resin and/or a plasticizer blended thereto, the resin containing, as a main component, thermoplastic base polymer such as ethylene-vinyl acetate copolymer, polyester, polyamide, polyolefin and polyurethane, or thermoplastic elastomer such as natural rubber, styrene-butadiene block copolymer, styrene-isoprene block copolymer, styrene-ethylene-butylene-styrene block copolymer and styrene-ethylene-propylene-styrene copolymer.

In order to improve the adhesion between the partition wall 12 and the heat sealing agent 22, the partition wall 12 may be subjected to a surface treatment such as an ultraviolet radiation or a plasma treatment. A primer may be formed thereon. Alternatively, a silane coupling agent may be added to the heat sealing agent 22.

As the other substrate 16, there may be typically used a substrate of a transparent film made of PE, PET, PES, PEN or the like, on which a transparent electrode formed of ITO, ZnO or the like is disposed. The transparent electrode may be formed by a coating method, a vapor deposition method and so on.

Similar to the thickness of the one substrate 11, a thickness of the other substrate 16 is preferably 10 μm to 2 mm. When the thickness is smaller than 10 μm, a strength required for a panel cannot be obtained, whereby there is an increased risk of destruction. On the other hand, when the thickness is larger than 2 mm, a weight of the panel is so heavy that it is difficult to handle, as well as a cost is increased. A range of a suitable thickness of the substrate 16 which is unlikely to be destroyed but easy to be handled is about 50 μm to 100 μm.

A further functional layer may be added to the other substrate 16. For example, a barrier film may be laminated onto a surface of the other substrate 16. When a transparent film, on which a barrier layer formed of a transparent inorganic film has been formed beforehand by vapor deposition or the like, is employed as the other substrate 16, the same function can be brought out. Alternatively, an ultraviolet cutting film may be laminated onto the surface of the other substrate 16. When the surface of the other substrate 16 is subjected to another ultraviolet cutting treatment, the same function can be brought out. An AG layer (antiglare layer), an HC layer (scratch prevention layer), an AR layer (antireflection layer) and so on may be added as another surface coating layer.

The other substrate 16 may be in a rolled condition or in a sheet condition.

A peripheral sealing agent may be formed of a thermoset resin, a cold curing resin, a heat sealing resin and so on, in addition to an ultraviolet curing resin. These resins may be applied to a periphery of each of the substrates 11 and 16 by a dispenser, or by any one of various printing methods, or by thermal contact bonding.

Next, actually conducted Examples and Comparative Examples are explained.

### Example 1

As one substrate 11, there was used a substrate made of no alkali glass having a size of 150 mm×150 mm×0.7 mm in thickness (manufactured by Nippon Electric Glass Co., Ltd., OA-10G), on which a Cu electrode was formed in pattern. The patterning of the Cu electrode was carried out by a general etching method.

Then, a negative type photosensitive resin material (dry film resist manufactured by DuPont MRC Dry Film Resist Co., Ltd.) was laminated at a thickness of 30 μm on the one substrate 11. The one substrate 11 laminated with the negative type photosensitive resin material was heated at 100° C. for one minute. Thereafter, the one substrate 11 laminated with the negative type photosensitive resin material was exposed (light exposure: 500 mJ/cm²) with the use of an exposure mask, developed for thirty seconds with the use of 1% KOH solution, and then baked at 200° C. for sixty minutes, so that a partition wall 12 in a lattice pattern was formed. In the partition wall 12, a line width of a top surface was 10 μm and a cell pitch was 600 μm.

A polyethylene terephthalate (PET) film (manufactured by Teijin DuPont Films Japan Limited) having a thickness of 50 μm was used as a transfer film base material 21. A heat sealing agent 22 (manufactured by Toyobo Co., Ltd., Vylon 630) was applied to the transfer film base material 21 at a thickness of 10 μm by a die coater, and was then dried. Thus, a rolled transfer film 20 having an adhesive layer 22 of 10 μm was manufactured.

After that, the transfer film 20 was placed on an upper surface of the partition wall 12. Under this condition, while a pressing force of about 1 kPa was further applied, a periphery of the heat sealing agent 22 was heated at a temperature over its softened temperature, e.g., about 120° C. Thus, the heat sealing agent 22 having a thickness of 5 μm was thermally transferred to a whole top surface of the partition wall 12. A thermal transfer ratio at this time was 5 μm/10 μm=50%.

Following thereto, as a display medium, an ink 13 containing following ingredients was dropped down from a dispenser 31, and squeegeed by a central squeegee 32 (squeegee 1 manufactured by Newlong Co., Ltd.: formed of urethane resin) so that the ink 13 was filled into each cell. The excessive ink protruding at both sides in a substrate width direction was trimmed off by side squeegees 33a and 33b (squeegees 2 manufactured by Newlong Co., Ltd.: formed of urethane resin), and was further wiped by a roll wiper 34.

<Ink Ingredients>

Electrophoretic particles (titanium dioxide) . . . 60 parts by weight

Fluid dispersion . . . 40 parts by weight

Succeeding thereto, a silver paste (Fujikura Kasei Co., Ltd.) was applied like dots on a part (square area of 2 mm×2 mm) of a periphery of a partition wall pattern by a dispenser 41.

Then, as another substrate 16, there was prepared a substrate made of a polyethylene terephthalate (PET) film (manufactured by Toyobo, A4100) having a size of 140 mm×140 mm×0.125 mm in thickness, with an indium tin oxide (ITO) vapor deposition film of a thickness of 0.2 μm being provided as a transparent electrode on one surface of the film. The transparent electrode was formed by a general film deposition method such as a sputtering method, a vacuum vapor deposition method, a CVD method and the like. The transparent electrode may be formed of zinc oxide (ZnO), tin oxide (SnO) and so on, in addition to indium tin oxide (ITO).

Thereafter, in an atmosphere, the other substrate 16 was superposed on the adhesive layer 22 on the partition wall 12 of the one substrate 11. Under this condition, while a predetermined thermal contact bonding pressure was further applied, the partition wall 12 of the one substrate 11 and the other substrate 16 were adhered to each other, with the excessive ink exceeding a cell capacity in the partition wall 12 being extruded (see FIG. 7). A temperature upon the thermal contact bonding was 120° C. The thermal contact bonding pressure was 0.1 MPa.

Thereafter, the thus obtained structure was cut into a predetermined size. An ultraviolet cuing resin (manufactured by EHC Co., Ltd.: LCB-610) was applied by means of a dispenser (not shown) to a periphery of each of the substrates 11 and 16 so as to seal the structure. Then, the ultraviolet curing resin was exposed to ultraviolet light (light exposure: 700 mJ/cm²) so as to be cured (peripheral sealing step). In this manner, a display device was manufactured.

A display quality of the thus obtained display panel was evaluated, and the result was significantly excellent. In addition, a local pressure was applied from outside, and a display quality change was evaluated. To be specific, a pressure of 1 MPa was applied to the display panel for ten seconds by a metal piece having an area of 10 mm×10 mm, then the pressure was returned to an atmospheric pressure. Under this condition, a display quality change was evaluated. Neither display irregularity nor unsatisfactory display occurred. In addition, no cell was destroyed.

### Comparative Example 1-1

A comparative display panel was manufactured in the same manner as that of Example 1, excluding that the heat sealing layer was not formed.

A display quality of the thus obtained display panel was evaluated, and the result was significantly excellent. However, when a local pressure of 1 MPa was applied to the display panel for ten seconds by a metal piece having an area of 10 mm×10 mm, and then the pressure was returned to an atmospheric pressure, the ink 13 excessively flew between the cells to invite display irregularity. Namely, at the pressurized position, the contrast was deteriorated.

### Comparative Example 1-2

Another comparative display panel was manufactured in the same manner as that of Example 1, excluding that a thermal contact bonding pressure in the step of adhering the other substrate was 0.01 MPa.

A display quality of the thus obtained display panel was evaluated, and the result was significantly excellent. However, when a local pressure of 1 MPa was applied to the display panel for ten seconds by a metal piece having an area of 10 mm×10 mm, and then the pressure was returned to an atmospheric pressure, the ink 13 excessively flew between the cells to invite display irregularity. Namely, at the pressurized position, the contrast was deteriorated.

### Comparative Example 1-3

Yet another comparative display panel was manufactured in the same manner as that of Example 1, excluding that a thermal contact bonding pressure in the step of adhering the other substrate was 0.4 MPa.

A display quality of the thus obtained display panel was evaluated, and the result was significantly excellent. However, when a local pressure of 1 MPa was applied to the display panel for ten seconds by a metal piece having an area of 10 mm×10 mm, and then the pressure was returned to an atmospheric pressure, deformation of the partition wall 12 was seen, which invited unsatisfactory display. Namely, at the pressurized position, a black and white display could not be achieved.

### Example 2

A display panel was manufactured in the same manner as that of Example 1, excluding that a thickness of the heat sealing layer was 2.5 μm, and that a thermal contact bonding pressure in the step of adhering the other substrate was 0.4 MPa.

A display quality of the thus obtained display panel was evaluated, and the result was significantly excellent. In addition, a local pressure was applied from outside, and a display quality change was evaluated. Neither display irregularity nor unsatisfactory display occurred. In addition, no cell was destroyed.

### Comparative Example 2-1

A comparative display panel was manufactured in the same manner as that of Example 2, excluding that a thermal contact bonding pressure in the step of adhering the other substrate was 0.1 MPa.

A display quality of the thus obtained display panel was evaluated, and the result was significantly excellent. However, when a local pressure of 1 MPa was applied to the display panel for ten seconds by a metal piece having an area of 10 mm×10 mm, and then the pressure was returned to an atmospheric pressure, the ink 13 excessively flew between the cells to invite display irregularity. Namely, at the pressurized position, the contrast was deteriorated.

As to the respective display panels of the above Examples and Comparative Examples, an adhesive area ratio of the other substrate 16 relative to the whole top surface of the partition wall 12 was evaluated by means of a microscope (manufactured by Olympus Co., Ltd., MHL110S). When both the substrates 11 and 16 are transparent, it is possible to evaluate the adhesive area ratio by transmitting measuring light through the display panel and by image processing a pattern of the transmitted light. Even when one of the substrates is opaque, it is possible to evaluate the adhesive area ratio by projecting measuring light from a side of the transparent substrate and by image processing a pattern of a reflected light.

FIG. 8 shows a definition of a width of the top surface of the partition wall 12. As shown in FIGS. 8(a) and 8(b), when corners of the top surface are not rounded, a width of the top surface is defined as it is. On the other hand, as shown in FIGS. 8(c) and 8(d), when the corners of the top surface are rounded, a width of the top surface is understood as a width between lines (edges) at which an extended surface of the top surface and an extended surface of a wall surface intersect with each other.

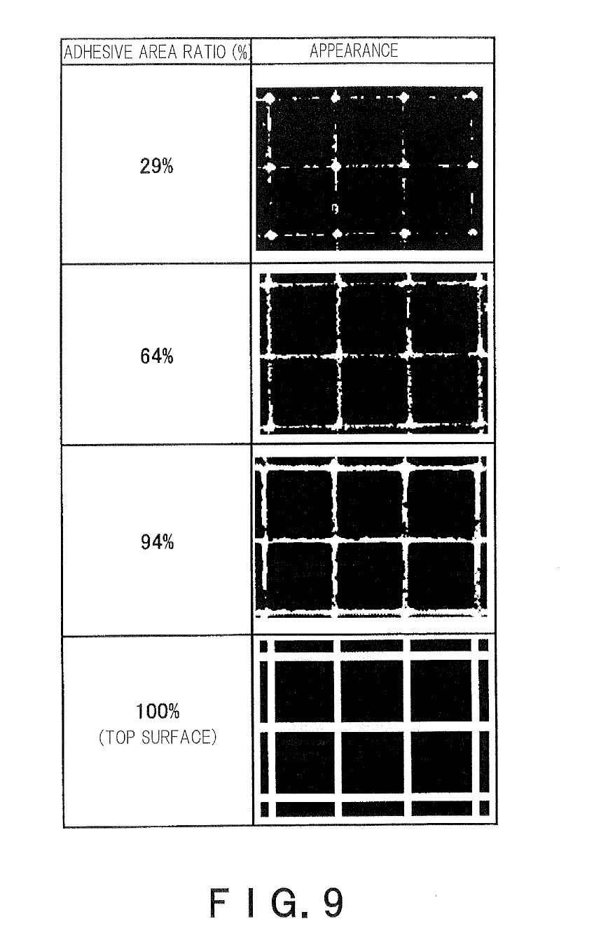

FIG. 9 shows corresponding examples between a pattern observed by the microscope and the adhesive area ratio. When the adhesive area ratio is small, it can be confirmed that the softened heat sealing agent 22 tends to build up at diverging points or intersection points in the top surface of the partition wall 12, and an amount of the softened heat sealing agent 22 tends to be small in an intermediate area between the diverging points or the intersection points of the top surface (a not-adhered portion remains). Herein, the diverging point or the intersection point of the partition wall 12 means a location that is the diverging point or the intersection point of the partition wall 12 in plan view. The intermediate area between the diverging points or the intersection points of the partition wall 12 means an intermediate area between the adjacent diverging points or the adjacent intersection points of the partition wall 12 in plan view. The shape of the partition wall 12 can be confirmed by a general high powered observation such as an optical observation by a microscope or an electron beam observation by a SEM.

The following Table 1 shows manufacturing conditions and evaluation results of the respective Examples and the respective Comparative Examples.

TABLE 1

| | Adhesive | Thermal | Adhesive | |
|---|---|---|---|---|
| | Layer | Contact | Area | Upon |
| | Thickness | Bonding | Ratio | Application of |
| | (μm) | Pressure (MPa) | (%) | Local Pressure |
| Example 1 | 5 | 0.1 | 50-80 | Excellent |
| Comparative | 0 | — | 0 | Unacceptable |
| Example 1-1 | | | | (Display |
| | | | | Irregularity) |
| Comparative | 5 | 0.01 | 10-40 | Unacceptable |
| Example 1-2 | | | | (Display |
| | | | | Irregularity) |
| Comparative | 5 | 0.4 | 90-100 | Unacceptable |
| Example 1-3 | | | | (Unsatisfactory |
| | | | | Display) |
| Example 2 | 2.5 | 0.4 | 50-80 | Excellent |
| Comparative | 2.5 | 0.1 | 10-40 | Unacceptable |
| Example 2-1 | | | | (Display |
| | | | | Irregularity) |

As can be understood from the results, when the adhesive layer 22 has a larger thickness, the adhesive area ratio tends to increase. Meanwhile, when the adhesive layer 22 has a smaller thickness, the adhesive area ratio tends to decrease. In addition, when the thermal contact bonding pressure in the step of adhering the other substrate is higher, the adhesive area ratio tends to increase. Meanwhile, when the thermal contact bonding pressure in the step of adhering the other substrate is lower, the adhesive area ratio tends to decrease. Namely, by suitably setting these manufacturing conditions, the other substrate 16 can be adhered only partially to the top surface of the partition wall 12. Thus, it is possible to manufacture a display panel which is free of display irregularity and unsatisfactory display, without a cell being destroyed, when a local pressure is applied from outside. In Table 1, the “contact area ratio (%)” is shown by the range such as 50 to 80 and 10 to 40. This is because references of the contact area ratio are “a maximum value and a minimum value, when the adhesive area ratio is evaluated at applied ten positions in a plane of the display panel within a measurement area of 0.3 mm×0.3 mm”.
11 One substrate (back plane base material)
111 Electrode
12 Partition wall
13 Ink (display medium)
16 Other substrate (front plane base material)
161 Electrode
20 Transfer film
21 Transfer film base material
22 Heat sealing agent (adhesive layer)
31 Dispenser
32 Central squeegee (squeegee 1)
33a, 33b Side squeegee (squeegee 2)
34 Roll wiper
41 Dispenser
51 Cutting device
91 Laminator
92 Hot plate
93 Metal piece

1-6. (canceled)

7. An electrophoretic display device including a display medium containing electrophoretic elements of at least one or more kind(s), which is enclosed between opposed two substrates at least one of which is transparent, the display medium being configured to display predetermined information when a predetermined electric field is applied between the two substrates, wherein:
a partition wall is formed in a predetermined pattern on one substrate;
the display medium is located in each of cells which are areas divided by the partition wall;
the other substrate is adhered partially to a top surface of the partition wall, so that a not-adhered portion remains; and
the top surface of the partition wall and the other substrate are adhered to each other at a range of not less than 50% relative to a total area of the top surface of the partition wall, while a movement of the display medium is maintained between the cells adjacent to each other.

8. The electrophoretic display device according to claim 7, wherein
the top surface of the partition wall and the other substrate are adhered to each other at a range of 50 to 80% relative to a total area of the top surface of the partition wall.

9. The electrophoretic display device according to claim 7, wherein
the top surface of the partition wall and the other substrate are adhered to each other by a heat sealing agent.

10. The electrophoretic display device according to claim 8, wherein
the top surface of the partition wall and the other substrate are adhered to each other by a heat sealing agent.

11. A method of manufacturing an electrophoretic display device including a display medium containing electrophoretic elements of at least one or more kind(s), which is enclosed between opposed two substrates at least one of which is transparent, the display medium being configured to display predetermined information when a predetermined electric field is applied between the two substrates, the method comprising:
a step of forming a partition wall in which a partition wall is formed in a predetermined pattern on one substrate;
a step of locating a display medium in which the display medium is located in each of cells which are areas divided by the partition wall; and
a step of adhering the other substrate in which the other substrate is adhered partially to a top surface of the partition wall of the one substrate;
wherein, in the step of adhering the other substrate, the top surface of the partition wall and the other substrate are adhered to each other at a range of not less than 50% relative to a total area of the top surface of the partition wall, while a movement of the display medium is maintained between the cells adjacent to each other.

12. The method of manufacturing an electrophoretic display device according to claim 11, wherein
in the step of adhering the other substrate, the other substrate is adhered at a range of 50 to 80% relative to a total area of the top surface of the partition wall.

13. The method of manufacturing an electrophoretic display device according to claim 11, wherein
the step of adhering the other substrate includes:
a step of forming an adhesive layer in which a heat sealing agent is transferred as an adhesive layer to the whole top surface of the partition wall; and
a heating step in which the transferred heat sealing agent is softened to provide an adhesive force.

14. The method of manufacturing an electrophoretic display device according to claim 12, wherein
the step of adhering the other substrate includes:
a step of forming an adhesive layer in which a heat sealing agent is transferred as an adhesive layer to the whole top surface of the partition wall; and
a heating step in which the transferred heat sealing agent is softened to provide an adhesive force.
